(19) United States
(12) Patent Application Publication
(10) Pub. No.: US 2025/0080901 A1
(43) Pub. Date: Mar. 6, 2025

(54) Serrated Waveguide

(71) Applicant: Barefoot Sound LLC, Portland, OR (US)

(72) Inventor: Thomas Barefoot, Portland, OR (US)

(73) Assignee: Barefood Sound LLC, Portland, OR (US)

(21) Appl. No.: 18/818,893

(22) Filed: Aug. 29, 2024

Related U.S. Application Data
(60) Provisional application No. 63/535,122, filed on Aug. 29, 2023.

(51) Int. Cl. H04R 1/28; H04R 7/04

(52) U.S. Cl. CPC H04R 1/2888; H04R 1/2876; H04R 7/04

(57) ABSTRACT

A speaker system having a first speaker and a first speaker diaphragm, a second speaker and a second speaker diaphragm. and a serrated waveguide, wherein the serrated waveguide acoustically couples the first speaker diaphragm with the second speaker diaphragm.

### CROSS-REFERENCE TO RELATED APPLICATIONS

This application, under 35 U.S.C. § 119, claims the benefit of U.S. Provisional Patent Application Ser. No. 63/535,122 filed on Aug. 29, 2023, and entitled “Serrated Waveguide,” the contents of which are hereby incorporated by reference herein.

### FIELD OF THE DISCLOSURE

This disclosure relates generally to audio loudspeakers. More particularly, this disclosure relates to acoustically coupling a central speaker diaphragm to a peripheral speaker diaphragm via a stationary central waveguide having serrated edges and scalloped surfaces and acoustically coupling the peripheral speaker diaphragm to a mounting baffle in the vicinity of the surround suspension via a stationary peripheral waveguide having serrated edges and scalloped surfaces.

### BACKGROUND

Audio loudspeakers are, of course, known and there have been many attempts to improve sound quality. For example, U.S. Pat. No. 2,201,059 discloses a loud-speaker comprising an inner edge and outer periphery of the spider preferably being serrated. U.S. Pat. No. 4,013,846 for a “Piston Loudspeaker” utilizes a rigid, light-weight diaphragm made of low-density cellular plastic, and includes a magnetically permeable keeper, two magnets, and a voice coil. U.S. Pat. No. 4,881,617 discloses an acoustic speaker a pie-shaped segments exemplified by segments that radiate outwardly from coil and terminate at flexible absorption ring. U.S. Pat. No. 6,026,929 is for a “High Frequency Radially Arcuated Center Speaker Cone with Variable Thickness” for high frequency speakers with cones that have arcuated segments and a thickness gradient. U.S. Pat. No. 6,334,505 for “Optimum Edges for Speakers and Musical Instruments” aims to improve acoustical antennas for various devices by reducing spatial irregularity of sound created by edge diffraction by providing a serrated-roll edge skirt, which reduces side lobes and edge diffractions. U.S. Pat. No. 7,146,021 for a “Whizzer Cone for Loudspeaker for Producing Uniform Frequency Response” describes a speaker cone with a base portion that has a front end with a plurality of discontinuities, which reduce distortion and improve frequency response. U.S. Pat. No. 8,607,925 is for a “Wedge-Shaped Acoustic Diffuser and Method of Installation” which is designed to both diffuse and reflect sound, while eliminating wasted space and consists of wells of variable depths, with reflective planes on the back of the wells. U.S. Pat. No. 9,467,782 discloses a diaphragm for a loudspeaker having a different number of corrugations in the inner and outer series. And U.S. Pat. No. 9,961,448 discloses a diaphragm and suspension edge that includes inner and suspension edge portions and one or more inner side elastic ribs protruding relative to the inner suspension edge body. However, none of the prior art attempts address the problems and issues with reflected sound waves that interfere and cause unwanted frequency response anomalies, turbulence, undesirable broadband chuffing, harmonic distortion, intermodulation of components, and the like.

For example, FIGS. 2A-2F illustrate embodiments of prior art loudspeakers and the above-noted and other deleterious aspects of the same. FIG. 2A illustrates a cross-section of a typical prior art coaxial loudspeaker assembly having a central speaker 201 and a peripheral speaker 202. The assembly incorporates a stationary central waveguide 208 having a circular superior peripheral edge 209, a circular superior central edge 214, and a circular inferior central edge 220. The inferior central edge 220 is proximal to the central diaphragm 203 of the central speaker 201. The superior central edge 214 and the inferior central edge 220 define a central surface 221 that is proximal to the central diaphragm 203. The central waveguide 208 functions as an acoustic waveguide transitioning between the central diaphragm 203 and the peripheral diaphragm 204 forming an effectively continuous horn when the peripheral diaphragm 204 is at its neutral displacement position.

FIG. 2B illustrates deleterious effects that arise when the peripheral diaphragm 204 is displaced in the superior direction 222. Sound waves 210 from the central diaphragm 203 moving radially superficial to the superior surface 219 of the central waveguide 208 are reflected off the inside surface 211 of the peripheral speaker 202 voice coil former 212. These reflected sound waves 210 interfere constructively and destructively with sound waves 215 emitted directly towards the receiver position 216 from the central diaphragm 203, thus causing unwanted frequency response anomalies at receiver position 216.

FIG. 2C illustrates deleterious effects that arise when the peripheral diaphragm 204 is displaced in the inferior direction 223. Sound waves 213 from the central diaphragm 203 moving radially superficial to the superior surface 219 of the central waveguide 208 are diffracted off the superior peripheral edge 209, of the central waveguide 208 due to the change in acoustic impedance. These diffracted sound waves 213 interfere constructively and destructively with sound waves 215 emitted directly towards the receiver position 216 from the central diaphragm 203, thus causing unwanted frequency response anomalies at receiver position 216.

FIG. 2D illustrates deleterious effects that arise when sound waves 225 emitted from the central diaphragm 203 move radially across the central diaphragm 203 and reflect off the central surface 221. These reflected sound waves 225 interfere constructively and destructively with sound waves 215 emitted directly towards the receiver position 216 from the central diaphragm 203, thus causing unwanted frequency response anomalies at receiver position 216.

FIG. 2E illustrates deleterious effects that arise when the peripheral diaphragm 204 is at its neutral position, or displaced in the superior direction 222, or displaced in the inferior direction 223. Sound waves 226 emitted from the central diaphragm 203 or from the peripheral diaphragm 204 moving radially superficial to the superior surface 219 of the central waveguide 208 and moving radially superficial to the peripheral diaphragm surface 227 are diffracted from the central edge 228 of the peripheral surround 229. Diffraction from the central edge 228 of the surround 229 occurs because the solid angle subtended by the superior surface 227 of the peripheral diaphragm 204 is less than the solid angle subtended by the baffle surface 230, thus sound waves 226 experience a change in acoustic impedance as they pass the central edge 228 of the peripheral surround 229. These diffracted sound waves 226 interfere constructively and destructively with sound waves 215 emitted directly towards the receiver position 216 from the central diaphragm 203, thus causing unwanted frequency response anomalies at receiver position 216.

FIG. 2F illustrates deleterious effects that arise when the peripheral diaphragm 204 moves dynamically in the superior direction 222 and the inferior direction 223. As the central edge 231 of the peripheral diaphragm 204 passes the superior peripheral edge 209 of the central waveguide 208 in either direction, air pressure fluctuations are generated due to the displacement of the superior surface 227 of the peripheral diaphragm 204 relative to the stationary superior surface 219 of the central waveguide 208. These pressure fluctuations cause turbulent air flow 233 in the region around the gap 232 between the central waveguide 208 and the voice coil former 212. The turbulent air flow 233 generates undesirable broadband chuffing noise as well as harmonic distortion and intermodulation components of the acoustic signal produced by the peripheral diaphragm 204. Other disadvantages, drawbacks, inconveniences, inefficiencies, and issues with current systems and devices may also exist.

### SUMMARY

Accordingly, disclosed embodiments address the above and other disadvantages, drawbacks, inconveniences, inefficiencies, and issues of current systems and devices.

Disclosed embodiments include a speaker assembly having a peripheral speaker having a first centerline, a central speaker having a second centerline, wherein second centerline is aligned with the first centerline, a central speaker diaphragm, a peripheral speaker diaphragm, a central waveguide, the central waveguide includes a first plurality of serrations and wherein the central speaker diaphragm is acoustically coupled with peripheral speaker diaphragm via the central waveguide, a peripheral waveguide, a surround suspension positioned between the peripheral speaker diaphragm and the peripheral waveguide, and a baffle, wherein the peripheral speaker diaphragm is acoustically coupled with the baffle via the peripheral waveguide.

In some embodiments the peripheral waveguide includes a second plurality of serrations. Some embodiments include a ring positioned between the surround suspension and the peripheral waveguide. In some embodiments the ring is an acoustically absorbent material.

In some embodiments the central waveguide includes a first central inferior edge, a first central superior edge, a first peripheral superior edge, a first peripheral inferior edge, a first superficial surface, the first superficial surface being defined by the first central superior edge and the first peripheral superior edge, wherein the first plurality of serrations are on the first superficial surface, and a first peripheral surface, the first peripheral surface being defined by the first peripheral superior edge and the first peripheral inferior edge.

In some embodiments the first central inferior edge is proximal to the central speaker diaphragm. In some embodiments the first superior peripheral edge extends above and below a central edge of the peripheral speaker diaphragm. In some embodiments the first peripheral surface is smooth. In some embodiments the first peripheral surface includes a third plurality of serrations.

In some embodiments the peripheral waveguide includes a second central inferior edge, a second central superior edge, a second peripheral superior edge, a second peripheral inferior edge, a second superficial surface, the second superficial surface being defined by the second central superior edge and the second peripheral superior edge, wherein the second plurality of serrations are on the second superficial surface, and a second peripheral surface, the second peripheral surface being defined by the second peripheral superior edge and the second peripheral inferior edge.

Some embodiments include an extended central surface, wherein the peripheral speaker is positioned axially between the central speaker and the central waveguide, and wherein the extended central surface acoustically couples the central speaker diaphragm to the central waveguide.

Disclosed embodiments also include a waveguide having a central inferior edge, a central superior edge, a peripheral superior edge, a peripheral inferior edge, a superficial surface, the superficial surface being defined by the central superior edge and the peripheral superior edge, the superficial surface including a first plurality of peaks and troughs, and a peripheral surface, the peripheral surface being defined by the peripheral superior edge and the peripheral inferior edge.

In some embodiments the waveguide has a substantially circular shape. In some embodiments the waveguide has an oval, elliptical, or rectangular shape. In some embodiments the first plurality of peaks and troughs are defined by a quadratic residue diffuser formula, primitive root diffuser formula, or the like.

In some embodiments the waveguide may include a first height between the peripheral inferior edge and the peripheral superior edge, wherein the first height varies around an outer perimeter of the waveguide. In some embodiments the waveguide may include a second height between the central inferior edge and the central superior edge, wherein the second height varies around an inner perimeter of the waveguide. In some embodiment the peripheral surface includes a second plurality of peaks and troughs.

Also disclosed is a speaker system having a first speaker and a first speaker diaphragm, a second speaker and a second speaker diaphragm, and a first serrated waveguide, wherein the first serrated waveguide acoustically couples the first speaker diaphragm with the second speaker diaphragm. In some embodiments the speaker system includes a third speaker and a third speaker diaphragm, a second serrated waveguide, wherein the second serrated waveguide acoustically couples the second speaker diaphragm with the third speaker diaphragm, a baffle, and a third serrated waveguide, wherein the third serrated waveguide acoustically couples the third speaker diaphragm with the baffle. Other embodiments also exist.

### BRIEF DESCRIPTION OF THE DRAWINGS

FIG. 1 illustrates an isometric view of a loudspeaker assembly in accordance with disclosed embodiments.

FIGS. 2A-2F illustrate various cut-away and exploded views of embodiments of prior art loudspeakers.

FIG. 3 illustrates a cut-away, isometric view of a loudspeaker assembly in accordance with disclosed embodiments.

FIG. 4 illustrates an isometric view in a cylindrical coordinate system of general features of a serrated waveguide in accordance with disclosed embodiments.

FIG. 5 illustrates a cut-away, isometric view of a serrated waveguide in accordance with disclosed embodiments.

FIG. 6 illustrates a cross-section, isometric view of a loudspeaker assembly having a central speaker mounted inferior to the motor of the peripheral speaker in accordance with disclosed embodiments.

FIG. 7 illustrates an embodiment of a serrated waveguide having a central surface and a superior surface having a scalloped topology following a quadratic residue diffuser formula in accordance with disclosed embodiments.

FIG. 8 illustrates an isometric view of embodiments in which a series of coaxial speaker assemblies are nested within one another and each having serrated waveguides as acoustic transitions in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

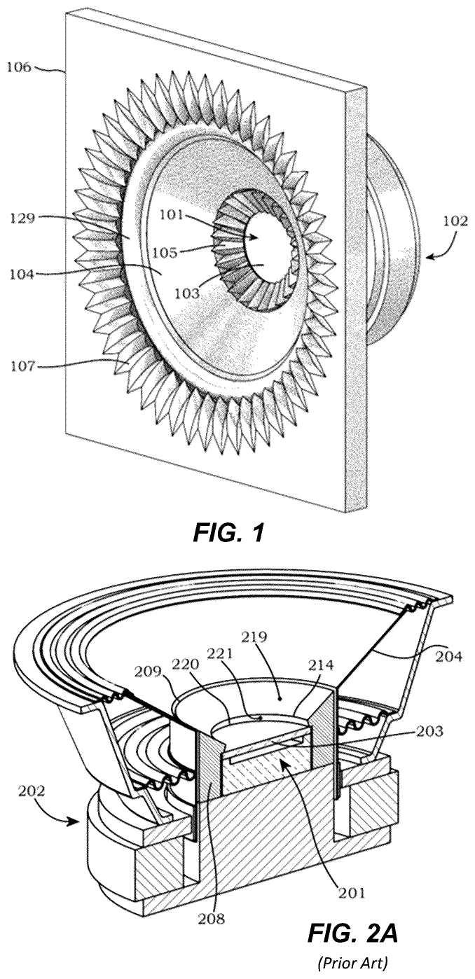

FIG. 1 illustrates an embodiment of the present disclosure comprised of a loudspeaker assembly that includes a central speaker 101 that is generally coaxial with a peripheral speaker 102. The central speaker diaphragm 103 is acoustically coupled to the peripheral speaker diaphragm 104 via a stationary central waveguide 105 having serrated edges and scalloped surfaces such that the central waveguide 105 and the peripheral diaphragm 104 form a unified horn that provides acoustic impedance matching between the central speaker diaphragm 101 and the free air. Furthermore, the peripheral speaker diaphragm is acoustically coupled to a mounting baffle 106 in the vicinity of the surround suspension 129 via a stationary peripheral waveguide 107 having serrated edges and scalloped surfaces.

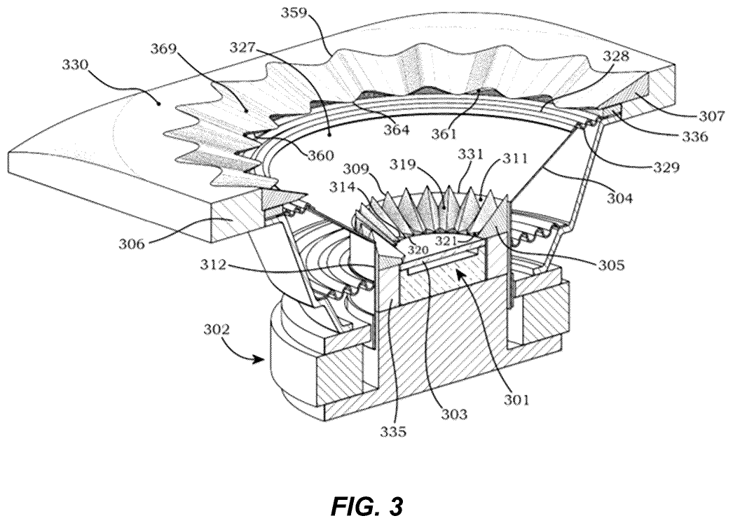

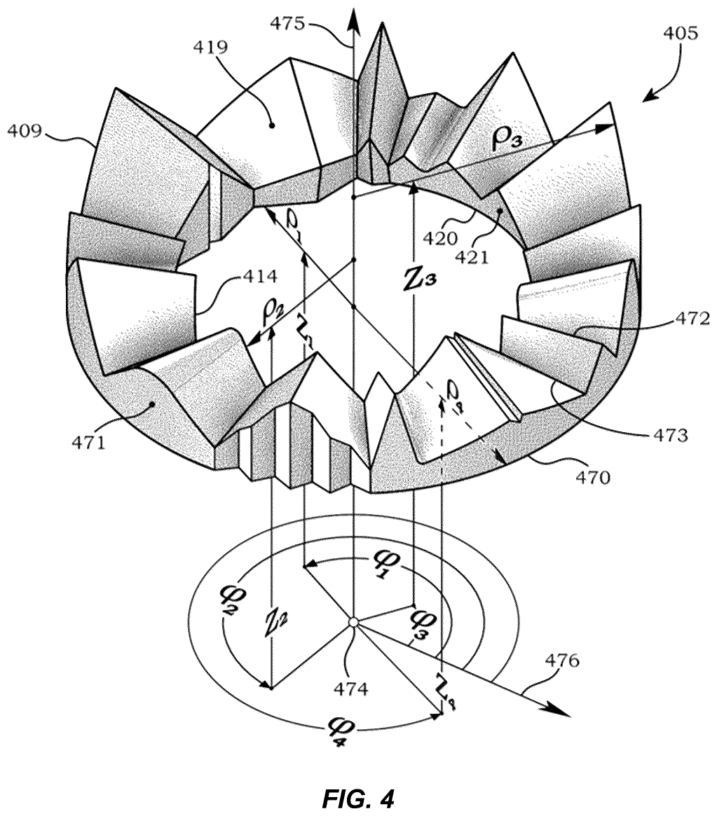

FIG. 3 illustrates a cut-away, isometric view of an embodiment of the present disclosure comprised of a loudspeaker assembly that includes a central speaker 301 that is generally coaxial with a peripheral speaker 302. The central speaker diaphragm 303 is acoustically coupled to the peripheral speaker diaphragm 304 via a stationary serrated central waveguide 305 having serrated edges and scalloped surfaces such that the serrated central waveguide 305 and the peripheral diaphragm 304 form a unified horn that provides acoustic impedance matching between the central speaker diaphragm 301 and the free air. The peripheral speaker diaphragm is acoustically coupled to the mounting baffle 306 in the vicinity of the surround suspension 329 via a stationary serrated peripheral waveguide 307 having serrated edges and scalloped surfaces.

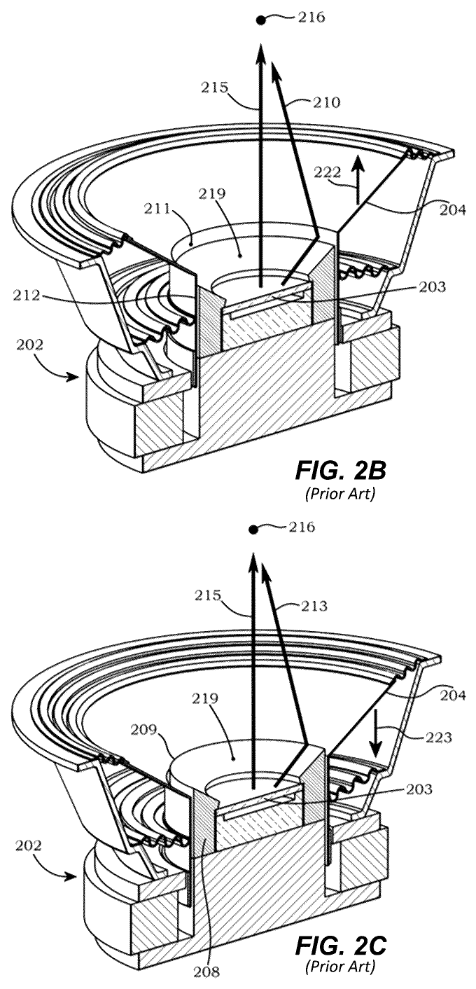

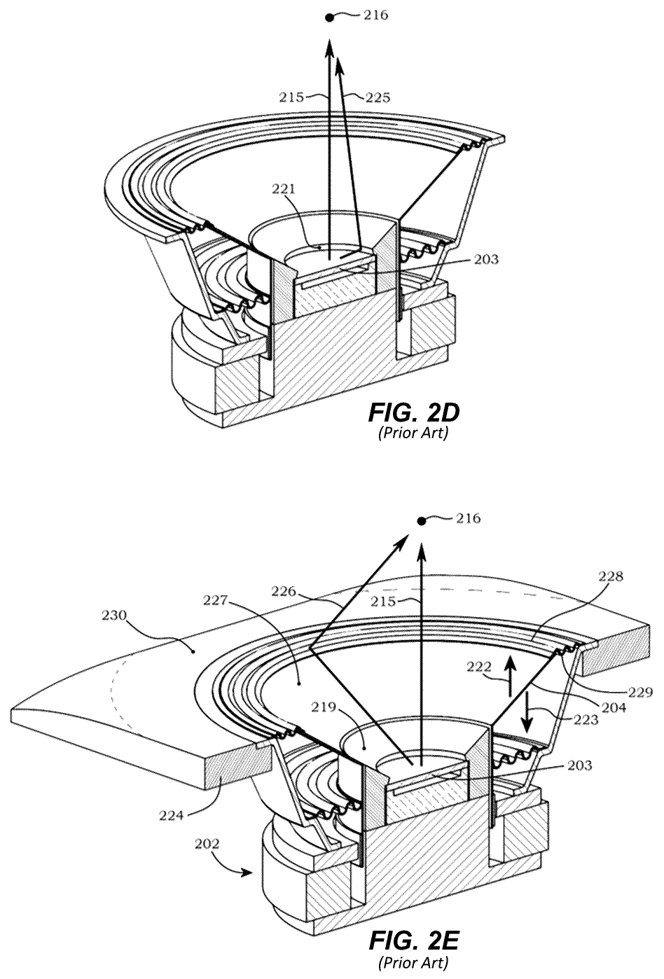

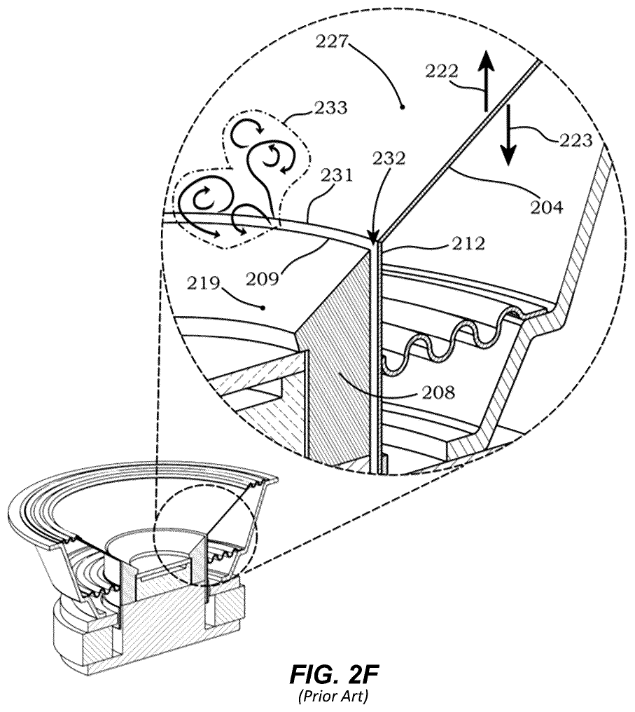

In some embodiments the serrated central waveguide 305 is affixed to the central support 335 such that its inferior central edge 320 is proximal to the central diaphragm 303. The serrated central waveguide 305 has a serrated superior peripheral edge 309 that extends superior to and inferior to the central edge 331 of the peripheral diaphragm 304 and has a central superior surface 319. These features reduce the deleterious effects illustrated in FIGS. 2B-2C of reflected and diffracted sound waves emitted from the central diaphragm 303 by creating time averaged diffuse reflections from the inside surface 311 of the peripheral speaker 302 voice coil former 312 and by creating time averaged diffuse diffractions from the serrated superior peripheral edge 309 as the peripheral diaphragm 304 oscillates. Furthermore, at any instantaneous position of the peripheral diaphragm 304 the serrated central waveguide 305 simultaneously produces reflected and diffracted sound waves from the region near the central diaphragm edge 331. These simultaneous reflected and diffracted sound waves reduce frequency response anomalies at receiver position 216 because the reflected and diffracted sound waves have dissimilar phase polarities rather than similar phase polarities as in the case where the unwanted sounds waves are either purely reflected or purely refracted.

Embodiments of the serrated central waveguide 305 have a serrated superior central edge 314 that extends superior to the inferior central edge 320 by varying distances such that the central surface 321 has a serrated profile. The serrated profile of the central surface 321 in combination with the scalloped superior surface 319 reduces the deleterious effects illustrated in FIG. 2D by diffusing sound reflection from the central diaphragm 303.

Embodiments of the serrated peripheral waveguide 307 have a serrated superior central edge 364 that extends superior to the inferior central edge 360 by varying distances such that the central surface 361 has a serrated topology. The serrated peripheral waveguide 307 has a serrated superior peripheral edge 359 that extends radially from the serrated superior central edge 364 by varying distances such that the peripheral superior surface 369 has a scalloped topology. These features reduce the deleterious effects illustrated in FIG. 2E of diffracted sound waves from the central edge 328 of the surround 329 by creating diffraction components at varying distances from the central axis, therefore diffusing the response anomalies at the receiver position.

Embodiments of the serrated superior peripheral edge 309 of the serrated central waveguide 305 extend superior to and inferior to the central edge 331 of the peripheral diaphragm 304 thus creating a more gradual transition between the central woofer cone edge and the peripheral tweeter waveguide edge. This reduces the deleterious effects of turbulence and its associated noise and distortion components illustrated in FIG. 2F.

In some embodiments an inferior absorber ring 336 composed of acoustically absorbent material can be included in the region between the peripheral waveguide 307 and the surround 329 in order to absorb sound waves diffracted off the peripheral edge 364 that subsequently radiate into this region. The acoustically absorbent material may be, but is not limited to, polyurethane foam, wool felt, or the like.

FIG. 4, using cylindrical coordinates having an origin 474, longitudinal axis, 475, and polar axis 476, illustrates general features of a serrated waveguide 405 that can represent either a central serrated waveguide 305 or peripheral serrated waveguide 307 as disclosed with reference to FIG. 3. However, the present disclosure is not limited to speakers having rotational symmetry about a longitudinal axis. Speakers having oval, elliptical, rectangular, and other diaphragm shapes are also claimed as would be appreciated by one of ordinary skill in the art having the benefit of this disclosure.

Embodiments of the central inferior edge 420 are defined by ρ1(φ) and z1(φ) where ρ1 and z1 can be either constant, periodic or quasiperiodic functions of the azimuthal angle φ. Additionally, ρ1(φ) and z1(φ) can be either continuous (constant, sinusoidal, etc.) or discontinuous (sawtooth, triangle, square, etc.) functions of the azimuthal angle φ and having varying radial and longitudinal amplitudes.

Embodiments of the central superior edge 414 are defined by ρ2(φ) and z2(φ). One feature of presently disclosed embodiments is that z2 need not be a constant and can be either a periodic or quasiperiodic function of the azimuthal angle φ. Additionally, z2(φ) can be either continuous (sinusoidal, etc.) or discontinuous (sawtooth, triangle, square, etc.) functions of the azimuthal angle φ and having varying longitudinal or radial amplitudes. The peak-to-peak longitudinal amplitudes of the central superior edge 414 may typically range from 1/10 times the shortest wavelength to 10 times the longest wavelength for which the coaxial speaker assembly is intended to be used. The peak-to-peak azimuthal distances of the central superior edge 414 may typically range from 1/10 times the shortest wavelength to 10 times the longest wavelength for which the coaxial speaker assembly is intended to be used. ρ2 can be either a constant, a periodic or a quasiperiodic function of the azimuthal angle φ. Additionally, ρ2(φ) can be either a continuous (sinusoidal, etc.) or a discontinuous (sawtooth, triangle, square, etc.) function of the azimuthal angle φ and having varying radial and longitudinal amplitudes.

Embodiments of the peripheral superior edge 409 are defined by ρ3(φ) and z3(φ). One feature of presently disclosed embodiments is that z2 need not be a constant and can be either a periodic or quasiperiodic function of the azimuthal angle φ. Additionally, z3(φ) can be either continuous (sinusoidal, etc.) or discontinuous (sawtooth, triangle, square, etc.) functions of the azimuthal angle φ and having varying longitudinal or radial amplitudes. The peak-to-peak longitudinal amplitudes of the peripheral superior edge 409 may typically range from 1/10 times the shortest wavelength to 10 times the longest wavelength for which the coaxial speaker assembly is intended to be used. The peak-to-peak azimuthal distances of the peripheral superior edge 409 may typically range from 1/10 times the shortest wavelength to 10 times the longest wavelength for which the coaxial speaker assembly is intended to be used. ρ3 can be either a constant, a periodic or a quasiperiodic function of the azimuthal angle φ. Additionally, ρ3(φ) can be either a continuous (sinusoidal, etc.) or a discontinuous (sawtooth, triangle, square, etc.) function of the azimuthal angle φ and having varying radial and longitudinal amplitudes.

Embodiments of the peripheral inferior edge 470 are defined by ρ4(φ) and z4(φ) where ρ4 and z4 can be either constant, periodic or quasiperiodic functions of the azimuthal angle φ. Additionally, ρ4(φ) and z4(φ) can be either continuous (constant, sinusoidal, etc.) or discontinuous (sawtooth, triangle, square, etc.) functions of the azimuthal angle φ and having varying radial and longitudinal amplitudes.

Embodiments of the central surface 421 are bounded by the central inferior edge 420 and the central superior edge 414 and can be either smooth or scalloped. The scalloped topology of the central surface 421 can be either continuous (sinusoidal, etc.) or discontinuous (sawtooth, triangle, square, etc.).

Embodiments of the superficial surface 419 are bounded by the central superior edge 414 and the peripheral superior edge 409. One feature of the presently disclosed embodiments is that the superficial surface 419 is scalloped. Its peaks 472 and troughs 473 radiate from the longitudinal axis 475. The scalloped topology of the superficial surface 419 can be either continuous (sinusoidal, etc.) or discontinuous (sawtooth, triangle, square, etc.). The longitudinal distances between peaks 472 and troughs 473 may typically range from 1/10 times the shortest wavelength to 10 times the longest wavelength for which the coaxial speaker assembly is intended to be used. The azimuthal distances between peaks 472 and troughs 473 may typically range from 1/10 times the shortest wavelength to 10 times the longest wavelength for which the coaxial speaker assembly is intended to be used.

Embodiments of the peripheral surface 471 are bounded by the peripheral superior edge 409 and the peripheral inferior edge 470 and can be either smooth or scalloped. The scalloped topology of the peripheral surface 471 can be either continuous (sinusoidal, etc.) or discontinuous (sawtooth, triangle, square, etc.).

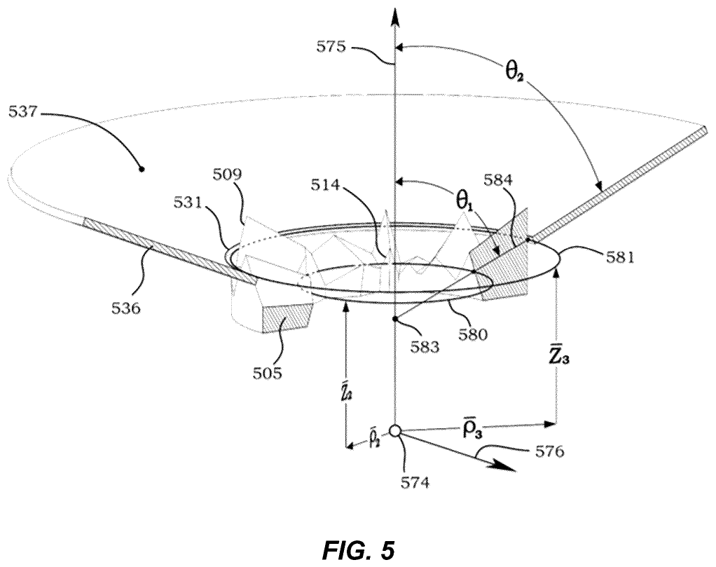

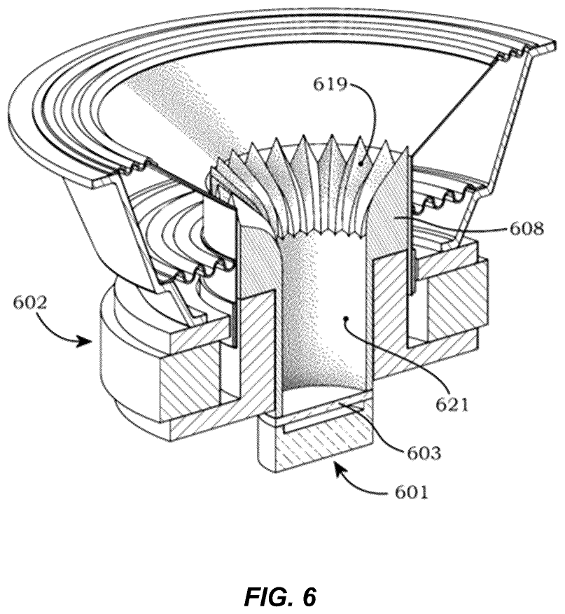

FIG. 5, using cylindrical coordinates having an origin 574, longitudinal axis, 575, and polar axis 576, illustrates general features of a serrated waveguide 505 that can represent either a central serrated waveguide 305 or peripheral serrated waveguide 307 as disclosed with reference to FIG. 3. However, the present disclosure is not limited to speakers having rotational symmetry about a longitudinal axis. Speakers having oval, elliptical, rectangular, and other diaphragm shapes are also claimed as would be appreciated by one of ordinary skill in the art having the benefit of this disclosure.

Embodiments of body 536 can represent either the peripheral cone 304 or the baffle mounting baffle 306 as shown in FIG. 3. Surface 537 can represent either the peripheral cone surface 327 or the baffle mounting baffle 330 as shown in FIG. 3. Embodiments of surface 537 define a cone whose apex lies on longitudinal axis 575 and having angle θ2.

In FIG. 5 central edge 531 can represent either the cone central edge 331 or the surround central edge 328 as disclosed with reference to FIG. 3. The central average line 580 may be defined as by the average longitudinal amplitude 22 and the average radial amplitude ρ̅2 of the central superior edge 514. The peripheral average line 581 may be defined as by the average longitudinal amplitude z̅3 and the average radial amplitude ρ̅3 of the central superior edge 509. The peripheral average line 581 lies in close proximity to the central edge 531, both having similar longitudinal positions.

Radial line 584 intersects central average line 580 and peripheral average line 581 and longitudinal axis 575 at apex 583. Radial line 584 and central average line 580 and peripheral average line 581 bound a cone with angle θ1 and apex 583.

The apex of the cone bounded by surface 537 is located at approximately the same longitudinal position 583 as the apex of the cone bounded by central average line 580, peripheral average line 581 and radial line 584 and where θ1≈θ2.

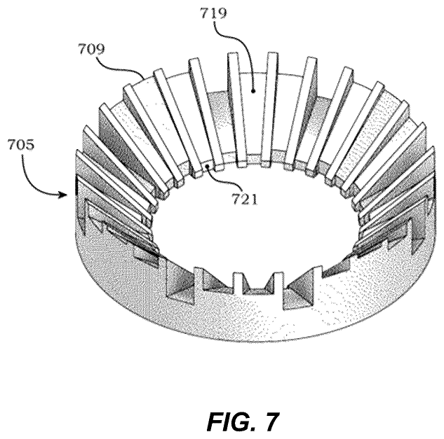

FIG. 6 illustrates a cross-section of a loudspeaker assembly having a central speaker 601 that is mounted inferior to the motor of the peripheral speaker 602. In order to accommodate this embodiment, the central waveguide 608 can include an extended central surface 621 of the central waveguide 608 such that the central surface 621 functions as a throat that acoustically couples the central diaphragm 603 to the central superior surface 619 of the central waveguide 608.

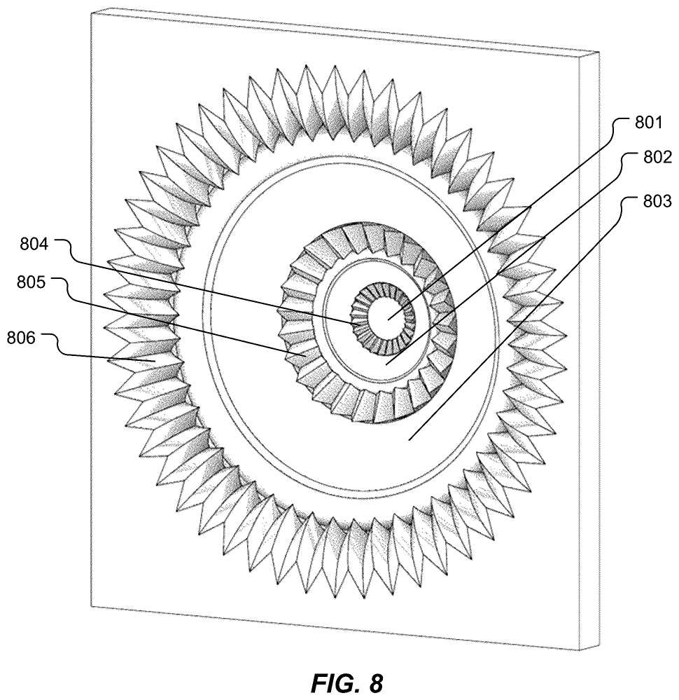

FIG. 7 illustrates an embodiment of a serrated waveguide 705 where the central surface 721 and the superior surface 719 have a scalloped topology following a quadratic residue diffuser formula. The serrated profile of superior peripheral edge 709 may provide the same benefits described with respect to the serrated waveguide disclosed in reference to FIG. 3.

FIG. 8 illustrates an embodiment of the present disclosure in which a series of coaxial speaker assemblies 801, 802, 803, are nested within one another and each having serrated waveguides 804, 805, 806 as acoustic transitions.

Although various embodiments have been shown and described, the present disclosure is not so limited and will be understood to include all such modifications and variations would be apparent to one skilled in the art.

What is claimed is:

1. A speaker assembly comprising:
a peripheral speaker having a first centerline;
a central speaker having a second centerline, wherein second centerline is aligned with the first centerline;
a central speaker diaphragm;
a peripheral speaker diaphragm;
a central waveguide, the central waveguide includes a first plurality of serrations and wherein the central speaker diaphragm is acoustically coupled with peripheral speaker diaphragm via the central waveguide;
a peripheral waveguide;
a surround suspension positioned between the peripheral speaker diaphragm and the peripheral waveguide; and
a baffle, wherein the peripheral speaker diaphragm is acoustically coupled with the baffle via the peripheral waveguide.

2. The speaker assembly of claim 1, wherein the peripheral waveguide includes a second plurality of serrations.

3. The speaker assembly of claim 2, further comprising a ring positioned between the surround suspension and the peripheral waveguide.

4. The speaker assembly of claim 3, wherein the ring is comprised of an acoustically absorbent material.

5. The speaker assembly of claim 2, where the central waveguide further comprises:
a first central inferior edge;
a first central superior edge;
a first peripheral superior edge;
a first peripheral inferior edge;
a first superficial surface, the first superficial surface being defined by the first central superior edge and the first peripheral superior edge, wherein the first plurality of serrations are on the first superficial surface; and
a first peripheral surface, the first peripheral surface being defined by the first peripheral superior edge and the first peripheral inferior edge.

6. The speaker assembly of claim 5, wherein the first central inferior edge is proximal to the central speaker diaphragm.

7. The speaker assembly of claim 6, wherein the first superior peripheral edge extends above and below a central edge of the peripheral speaker diaphragm.

8. The speaker assembly of claim 7, wherein the first peripheral surface is smooth.

9. The speaker assembly of claim 7, wherein the first peripheral surface includes a third plurality of serrations.

10. The speaker assembly of claim 7, wherein the peripheral waveguide further comprises:
a second central inferior edge;
a second central superior edge;
a second peripheral superior edge;
a second peripheral inferior edge;
a second superficial surface, the second superficial surface being defined by the second central superior edge and the second peripheral superior edge, wherein the second plurality of serrations are on the second superficial surface; and
a second peripheral surface, the second peripheral surface being defined by the second peripheral superior edge and the second peripheral inferior edge.

11. The speaker assembly of claim 1, further comprising:
an extended central surface;
wherein the peripheral speaker is positioned axially between the central speaker and the central waveguide; and
wherein the extended central surface acoustically couples the central speaker diaphragm to the central waveguide.

12. A waveguide comprising:
a central inferior edge;
a central superior edge;
a peripheral superior edge;
a peripheral inferior edge;
a superficial surface, the superficial surface being defined by the central superior edge and the peripheral superior edge, the superficial surface including a first plurality of peaks and troughs; and
a peripheral surface, the peripheral surface being defined by the peripheral superior edge and the peripheral inferior edge.

13. The waveguide of claim 12, wherein the waveguide has a substantially circular shape.

14. The waveguide of claim 12, wherein the waveguide has an oval, elliptical, or rectangular shape.

15. The waveguide of claim 12, wherein the first plurality of peaks and troughs are defined by a quadratic residue diffuser formula, primitive root diffuser formula, or the like.

16. The waveguide of claim 12, further comprising a first height between the peripheral inferior edge and the peripheral superior edge, wherein the first height varies around an outer perimeter of the waveguide.

17. The waveguide of claim 16, further comprising a second height between the central inferior edge and the central superior edge, wherein the second height varies around an inner perimeter of the waveguide.

18. The waveguide of claim 17, wherein peripheral surface includes a second plurality of peaks and troughs.

19. A speaker system comprising:
a first speaker and a first speaker diaphragm;
a second speaker and a second speaker diaphragm; and
a first serrated waveguide, wherein the first serrated waveguide acoustically couples the first speaker diaphragm with the second speaker diaphragm.

20. The speaker system of claim 19, further comprising:
a third speaker and a third speaker diaphragm;
a second serrated waveguide, wherein the second serrated waveguide acoustically couples the second speaker diaphragm with the third speaker diaphragm;
a baffle; and
a third serrated waveguide, wherein the third serrated waveguide acoustically couples the third speaker diaphragm with the baffle.
